(19) United States
(12) Patent Application Publication
(10) Pub. No.: US 2015/0122473 A1
(43) Pub. Date: May 7, 2015

(54) VEHICLE AIR CONDITIONER

(71) Applicant: JAPAN CLIMATE SYSTEMS CORPORATION, Hiroshima (JP)

(72) Inventors: Satoshi NII, Hiroshima (JP); Hiroaki SHIGENAKA, Hiroshima (JP); Hideaki NISHII, Hiroshima (JP); Yoichi MIYAZAKI, Hiroshima (JP); Koji ASO, Hiroshima (JP)

(73) Assignee: JAPAN CLIMATE SYSTEMS CORPORATION, Hiroshima (JP)

(21) Appl. No.: 14/594,363

(22) Filed: Jan. 12, 2015

Related U.S. Application Data
(63) Continuation of application No. PCT/JP2013/004730, filed on Aug. 5, 2013.

(30) Foreign Application Priority Data
Aug. 9, 2012 (JP) 2012-177371

(51) Int. Cl. B60H 1/00; B60H 1/22

(52) U.S. Cl. CPC B60H 1/00021; B60H 1/2215; B60H 2001/00128; B60H 2001/0015
USPC 165/202

(57) ABSTRACT

A vehicle air conditioner includes an electric heater, an air mixing damper, a driver configured to drive the air mixing damper, and a controller configured to control the electric heater and the driver. The controller is configured to perform thermal capacity switching control such that when the thermal capacity of the electric heater is switched, a target opening degree of the air mixing damper is set such that the temperature of blowout air approximates a target temperature.

### CROSS-REFERENCE TO RELATED APPLICATIONS

This is a continuation of International Application No. PCT/JP2013/004730 filed on Aug. 5, 2013, which claims priority to Japanese Patent Application No. 2012-177371 filed on Aug. 9, 2012. The entire disclosures of these applications are incorporated by reference herein.

### BACKGROUND

The present disclosure relates to vehicle air conditioners mounted to, for example, vehicles, and the like.

In general, for example, a vehicle provided with an internal combustion engine includes a vehicle air conditioner for circulating cooling water of the internal combustion engine to heat air-conditioning air, whereas a vehicle provided with no internal combustion engine (e.g., an electric vehicle) includes a vehicle air conditioner for heating air-conditioning air by an electric heater having a plurality of PTC elements (see, for example, Japanese Unexamined Patent Publication No. H09-86148).

The air conditioner of Japanese Unexamined Patent Publication No. H09-86148 includes an electric heater provided in a casing into which air-conditioning air is introduced. The air conditioner further includes a heat accumulator provided downstream of the electric heater in an airflow direction and configured to accumulate heat by using power supplied from an external power supply. The heating capacity of the electric heater is changed in response to operation of a temperature adjusting lever by a passenger.

The vehicle air conditioner includes an air mixing damper configured to regulate amounts of cold air having passed through a cooling heat exchanger and warm air heated by the electric heater. The opening degree of the air mixing damper depends on the temperature set by a passenger, the outside air temperature, etc. The air mixing damper is driven by an actuator to a determined opening degree, so that an air-conditioned wind having an intended temperature can be generated and supplied to a cabin.

### SUMMARY

However, when an electric heater includes a plurality of PTC elements as described in Japanese Unexamined Patent Publication No. H09-86148, the thermal capacity is switched by supplying electric power to, for example, a first-phase PTC element, a second-phase PTC element, and a third-phase PTC element in this order.

In this case, when the supply of the electric power to the second-phase PTC element is started during the supply of the electric power to the first-phase PTC element, the thermal capacity of the electric heater rapidly increases. The rapid increase in heating capacity rapidly increases the temperature of air having passed through the electric heater. Therefore, if the opening degree of the air mixing damper is unchanged before the supply of the electric power to the second-phase PTC element, the temperature of blowout air becomes higher than a target temperature. This results in a problem where the comfort of passengers is reduced.

In view of the foregoing, the present disclosure is directed to a technique for improving the comfort of passengers, in the case of heating air by an electric heater whose capacity is switchable between a plurality of phases, by preventing the temperature of blowout air, which has been heated by the electric heater, from significantly deviating from a target temperature in switching the capacity of the electric heater.

A vehicle air conditioner includes:

a cooling heat exchanger configured to cool air-conditioning air;

an electric heater whose thermal capacity for heating the air-conditioning air is switchable in a plurality of phases;

an air mixing damper configured to regulate amounts of air having passed through the cooling heat exchanger and air having passed through the electric heater;

a driver configured to drive the air mixing damper; and

a controller configured to control the electric heater and the driver such that

the thermal capacity of the electric heater is switched, a target opening degree of the air mixing damper is computed, and the driver is operated to move the air mixing damper to the target opening degree so as to obtain blowout air at a target temperature.

When the controller switches the thermal capacity of the electric heater, the controller performs thermal capacity switching control of setting the target opening degree of the air mixing damper such that a temperature of the blowout air approximates the target temperature.

For example, when the thermal capacity of the electric heater is increased from a first-phase thermal capacity to a second-phase thermal capacity, the thermal capacity rapidly increases. However, in the present disclosure, the target opening degree of the air mixing damper is set such that the temperature of the blowout air approximates the target temperature, so that it is possible to prevent wide deviation of the temperature of the blowout air from the target temperature.

The controller may be configured to perform the thermal capacity switching control in a region except a maximum cooling region and a maximum heating region.

With this configuration, since the electric heater is in an OFF state in the maximum cooling region, the thermal capacity is not switched. Since the thermal capacity of the electric heater is maximum in the maximum heating region, the thermal capacity is not switched. Thus, in the regions in which the thermal capacity of the electric heater is not switched, the thermal capacity switching control is not performed, so that error control can be prevented.

The vehicle air conditioner further includes an insolation sensor configured to sense an amount of insolation, wherein

the controller may be configured to correct an opening degree of the air mixing damper based on the amount of insolation sensed by the insolation sensor.

With this configuration, the opening degree of the air mixing damper is set in consideration of the amount of insolation. Thus, the temperature of conditioned air can be suitably set.

The vehicle air conditioner further includes an outside air temperature sensor configured to sense a temperature outside a cabin, wherein

the controller may be configured to correct an opening degree of the air mixing damper based on the temperature outside the cabin sensed by the outside air temperature sensor.

With this configuration, the opening degree of the air mixing damper is set in consideration of the temperature outside the cabin. Thus, the temperature of conditioned air can be suitably set.

The controller may be configured to set the target opening degree such that to increase the thermal capacity of the electric heater, the air mixing damper is moved such that an opening degree of air mixing damper decreases to cool the air-conditioning air as compared to the opening degree before an increase in thermal capacity, whereas to reduce the thermal capacity of the electric heater, the air mixing damper is moved such that the opening degree of the air mixing damper increases to heat the air-conditioning air as compared to the opening degree before a reduction in thermal capacity.

With this configuration, in either of the case where the thermal capacity of the electric heater is increased and the case where the thermal capacity of the electric heater is reduced, it is possible to prevent wide deviation of the temperature of the blowout air from the target temperature.

The controller may be configured to change the opening degree of the air mixing damper based on the target temperature of the blowout air before switching the thermal capacity of the electric heater.

With this configuration, when a target temperature of the blowout air before switching the thermal capacity of the electric heater is relatively high, the opening degree of the air mixing damper can be increased to heat the air-conditioning air. When the target temperature of the blowout air before switching the thermal capacity of the electric heater is relatively low, the opening degree of the air mixing damper can be reduced to cool the air-conditioning air. Thus, the opening degree of the air mixing damper is set in consideration of the target temperature of the blowout air. Thus, the temperature of the conditioned air can be suitably set.

The controller may be configured to switch the thermal capacity of the electric heater based on a heater switching opening degree of the air mixing damper. The controller may be configured to increase a difference between the target opening degree of the air mixing damper and the heater switching opening degree as time approaches a timing of switching the thermal capacity of the electric heater.

With this configuration, the thermal capacity of the electric heater can be switched based on the heater switching opening degree of the air mixing damper. Before switching the thermal capacity of the electric heater, the air mixing damper is moved to a target opening degree which is an opening degree different from the heater switching opening degree, so that the difference between the heater switching opening degree and the target opening degree gradually increases. Thus, the temperature of the blowout air can be closer to the target temperature of the blowout air when the thermal capacity of the electric heater is switched than when the electric heater is operated with the air mixing damper open to the heater switching opening degree.

The vehicle air conditioner further includes: an air temperature sensor configured to sense a temperature of air heated by the electric heater, wherein

the controller may be configured to reduce the thermal capacity of the electric heater when the temperature of the air sensed by the air temperature sensor is higher than or equal to a first predetermined temperature.

With this configuration, the first predetermined temperature is set to a temperature which may cause thermal damage to, for example, a casing of the air conditioner. When the temperature of blowout air is higher than or equal to the first predetermined temperature, the thermal capacity of the electric heater can be lowered to avoid the thermal damage.

The controller may be configured to stop supplying electric power to the electric heater when the temperature of air sensed by the air temperature sensor is higher than or equal to a second predetermined temperature higher than the first predetermined temperature.

With this configuration, the thermal damage can be prevented in advance.

The vehicle air conditioner further includes an inside air temperature sensor configured to sense an air temperature in a cabin, wherein the controller may be configured to reduce the thermal capacity of the electric heater when in introducing inside air from the cabin into the vehicle air conditioner, the air temperature in the cabin sensed by the inside air temperature sensor is higher than the predetermined temperature.

With this configuration, when the air temperature in the cabin is higher than the predetermined temperature, and thus, a low heating capacity of the air conditioner is satisfactory, the thermal capacity of the electric heater can be lowered to reduce electric power consumption.

The vehicle air conditioner further includes: an outside air temperature sensor configured to sense an air temperature outside a cabin, wherein,

the controller may be configured to reduce the thermal capacity of the electric heater when in introducing outside air outside the cabin into the vehicle air conditioner, the air temperature outside the cabin sensed by the outside air temperature sensor is higher than a predetermined temperature.

With this configuration, when the temperature outside the cabin is higher than the predetermined temperature, and thus a low heating capacity of the air conditioner is satisfactory, the thermal capacity of the electric heater can be lowered to reduce electric power consumption.

The vehicle air conditioner includes: an inside air temperature sensor configured to sense an air temperature in a cabin; and

an outside air temperature sensor configured to sense a temperature outside the cabin, wherein

the controller may be configured to reduce the thermal capacity of the electric heater when at least one of the air temperature in the cabin sensed by the inside air temperature sensor or the temperature outside the cabin sensed by the outside air temperature sensor is higher than a predetermined temperature.

With this configuration, when a low heating capacity of the air conditioner is satisfactory, the thermal capacity of the electric heater can be lowered to reduce electric power consumption.

The vehicle air conditioner further includes: an air temperature sensor configured to sense a temperature of air heated by the electric heater, wherein

the controller may be configured to reduce the thermal capacity of the electric heater when the temperature of the air sensed by the air temperature sensor is higher than a target temperature of blowout air.

With this configuration, when the temperature of air heated by the electric heater is higher than the target temperature of the blowout air, a low heating capacity of the air conditioner is satisfactory. In this case, the thermal capacity of the electric heater can be lowered to reduce electric power consumption.

The vehicle air conditioner further includes: a cooling-side temperature sensor configured to sense a temperature of air having passed through the cooling heat exchanger, wherein

the controller may be configured to reduce the thermal capacity of the electric heater when the temperature sensed by the cooling-side temperature sensor is higher than the predetermined temperature.

With this configuration, when the temperature of air having passed through the cooling heat exchanger is higher than the predetermined temperature, and a low heating capacity of the air conditioner is satisfactory, the thermal capacity of the electric heater can be lowered to reduce electric power consumption.

The controller may be configured to move the air mixing damper after a predetermined delay time has elapsed since the thermal capacity of the electric heater was switched.

With this configuration, after switching the thermal capacity of the electric heater, the thermal capacity of the electric heater gradually changes. The delay time is set such that the air mixing damper is operated with a delay corresponding to the gradual change of the thermal capacity of the electric heater, so that a rapid change in temperature of the blowout air can be reduced when the thermal capacity of the electric heater is switched.

The controller may be configured to change a hysteresis for switching the thermal capacity of the electric heater based on a volume of blown air.

With this configuration, for example, a higher degree of air conditioning is required when the volume of blown air is high than when the volume of blown air is low. In this case, the hysteresis for switching the thermal capacity of the electric heater is shortened to rapidly switch the capacity, thereby obtaining a desirable air conditioning capacity.

The controller may be configured to switch the thermal capacity of the electric heater based on a heater switching opening degree of the air mixing damper, and the controller may shift a timing of switching the thermal capacity of the electric heater such that the heater switching opening degree of the air mixing damper decreases to cool the air-conditioning air as a volume of blown air increases, whereas the controller may shift the timing of switching the thermal capacity of the electric heater such that the heater switching opening degree of the air mixing damper increases to heat the air-conditioning air as the volume of the blown air decreases.

With this configuration, the heating capacity in heating is high when the volume of blown air is high. Therefore, even when the timing of switching the thermal capacity of the electric heater is shifted such that the heater switching opening degree of the air mixing damper decreases to cool the air-conditioning air, a desirable heating capacity can be ensured. When the volume of blown air is low, the heating capacity is low. Therefore, the timing of switching the thermal capacity of the electric heater is shifted such that the heater switching opening degree of the air mixing damper increases to heat the air-conditioning air, so that a desirable heating capacity can be ensured.

According to the present disclosure, the target opening degree of the air mixing damper is set such that the temperature of the blowout air approximates the target temperature of the blowout air when the thermal capacity of the electric heater is switched. Therefore, wide deviation of the temperature of the conditioned air from the target temperature in switching the capacity of the electric heater can be prevented to improve the comfort of passengers.

### BRIEF DESCRIPTION OF THE DRAWINGS

FIG. 1 is a view schematically illustrating a structure of a vehicle air conditioner according to an embodiment of the present disclosure.

FIG. 2 is a block diagram of a vehicle controller.

FIG. 3 is a perspective view of an electric heater.

FIG. 4 is a flow chart illustrating main control of the controller.

FIG. 5 is a flow chart illustrating sub-control of the controller.

FIG. 6 is a graph illustrating the relationship between the temperature of blowout air and the heater switching opening degree.

FIG. 7 is a graph illustrating a first table for setting the target opening degree of an air mixing damper.

FIG. 8 is a graph illustrating a second table for setting the target opening degree of the air mixing damper.

FIG. 9 is a graph illustrating a third table for setting the target opening degree of the air mixing damper.

### DETAILED DESCRIPTION

Embodiments of the present disclosure will be described in detail below based on the drawings. Note that the preferred embodiments described below are only for the illustrative purposes and are not intended to limit the applications and uses of the present disclosure.

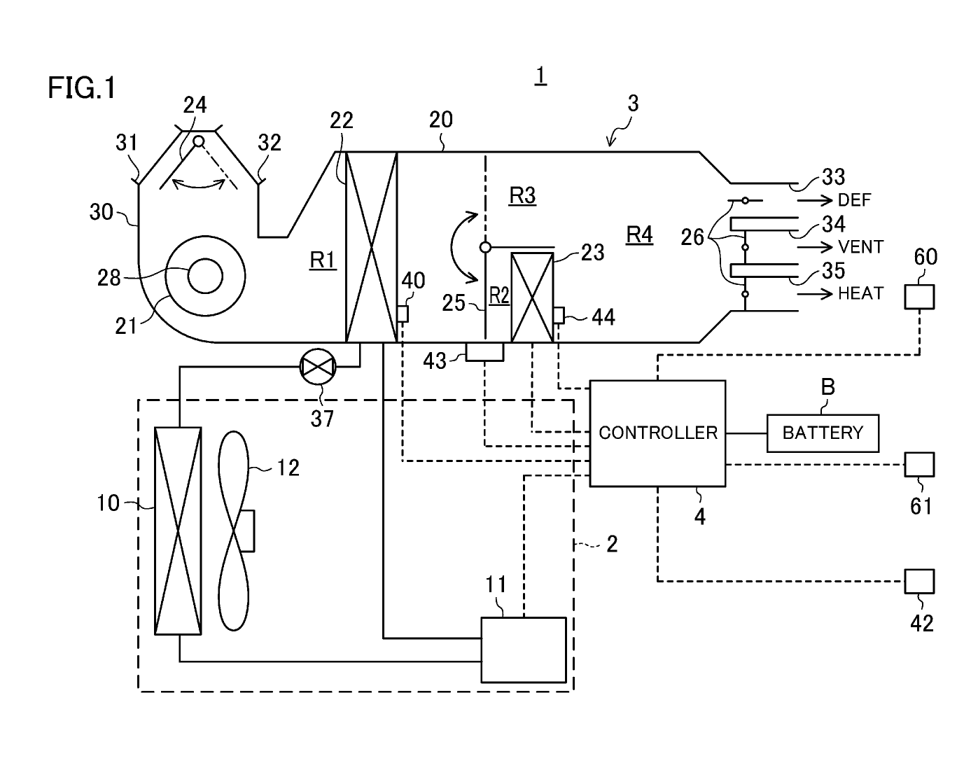

FIG. 1 is a view schematically illustrating a structure of a vehicle air conditioner 1 according to an embodiment of the present disclosure. The vehicle air conditioner 1 is to be mounted to a vehicle such as an automobile. The vehicle air conditioner 1 is configured to introduce air outside or inside a cabin thereinto so as to generate an air-conditioned wind having an intended temperature, and to supply the generated air-conditioned wind to each of spaces in the cabin.

The vehicle to which the air conditioner 1 is to be mounted is an electric vehicle including both a driving motor (not shown) and a battery B.

The vehicle air conditioner 1 includes an outdoor unit 2, an indoor unit 3, and a controller 4 configured to control the outdoor unit 2 and the indoor unit 3. The outdoor unit 2 is provided in a motor room in which, for example, the driving motor is to be mounted. The outdoor unit 2 includes a condenser 10 and an electric compressor 11 which are elements of a refrigeration cycle device and a blower 12 configured to send air to the condenser 10. The electric compressor 11 is turned ON and OFF by the controller 4, and the rotation speed of the electric compressor 11 is varied by the controller 4. The electric compressor 11 is supplied with electric power from the battery B.

The indoor unit 3 includes a casing 20, a blower 21 accommodated in the casing 20, an evaporator (cooling heat exchanger) 22, an electric heater 23, an inside/outside air switching damper 24, an air mixing damper 25, and blowout direction switching dampers 26.

An air passage is formed in the casing 20. An inside/outside air switch 30 is provided upstream of the casing 20 in an airflow direction. The inside/outside air switch 30 has an inside-air inlet 31 configured to introduce air in the cabin into the casing 20 and an outside-air inlet 32 configured to introduce air outside the cabin into the casing 20.

The inside/outside air switching damper 24 is provided in the inside/outside air switch 30 and is configured to open one of the inside-air inlet 31 and the outside-air inlet 32 and to close the other of the inside-air inlet 31 and the outside-air inlet 32.

The blower 21 is provided downstream of the inside/outside air switching damper 24 in the casing 20. The blower 21 is rotated by a blower motor 28. The blower motor 28 is turned ON and OFF by the controller 4, and the rotation speed of (the volume of air blown by) the blower motor 28 is varied by the controller 4.

The casing 20 has a cooling passage R1 for cooling air-conditioning air introduced into the casing 20, a heating passage R2 for heating a part of the air-conditioning air, a bypass passage R3 through which a part of the air-conditioning air bypassing the heating passage R2 flows, and an air mixing space R4 in which the parts of the air having passed through the heating passage R2 and the bypass passage R3 are mixed.

Specifically, the cooling passage R1 is formed downstream of the blower 21 in the airflow direction. A downstream portion of the cooling passage R1 is divided into two passages, one of which is connected to an upstream portion of the heating passage R2, and the other of which is connected to an upstream portion of the bypass passage R3. A downstream portion of the heating passage R2 and a downstream portion of the bypass passage R3 are connected to the air mixing space R4. A downstream portion of the air mixing space R4 is divided into three passages, i.e., a passage connected to a defroster outlet 33, a passage connected to a vent outlet 34, and a passage connected to a heat outlet 35.

The evaporator 22 is provided in the cooling passage R1. The air-conditioning air introduced into the casing 20 totally passes through the evaporator 22. The evaporator 22 is an element of the refrigeration cycle device. The evaporator 22 is provided with an expansion valve device 37. A refrigerant discharged from the condenser 10 is decompressed while passing through the expansion valve device 37. Then, the refrigerant flows into the evaporator 22. After circulation of the refrigerant in the evaporator 22, the refrigerant is sucked into the electric compressor 11.

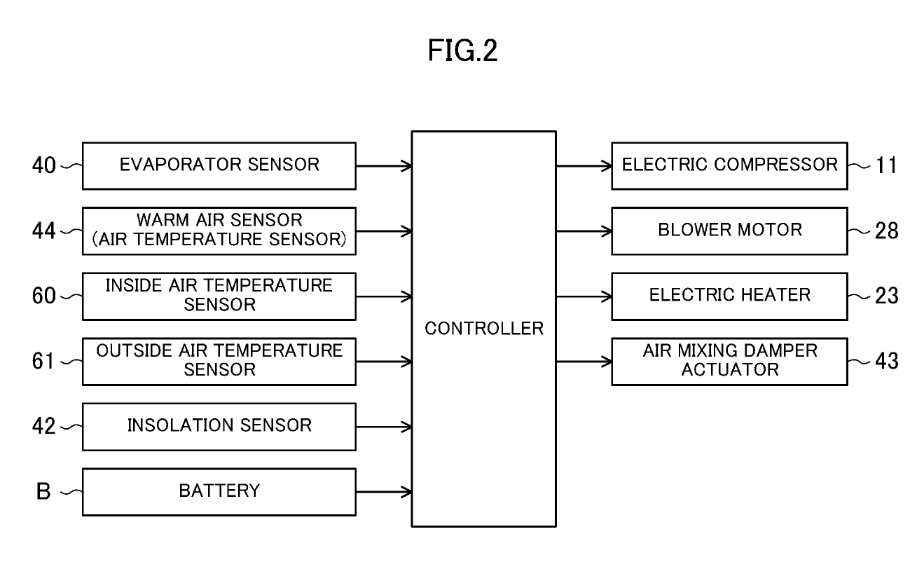

The evaporator 22 is provided with an evaporator sensor (cooling-side temperature sensor) 40 configured to sense the temperature of air having passed through the evaporator 22. As illustrated also in FIG. 2, the evaporator sensor 40 is connected to the controller 4 and is configured to output the sensed temperature to the controller 4.

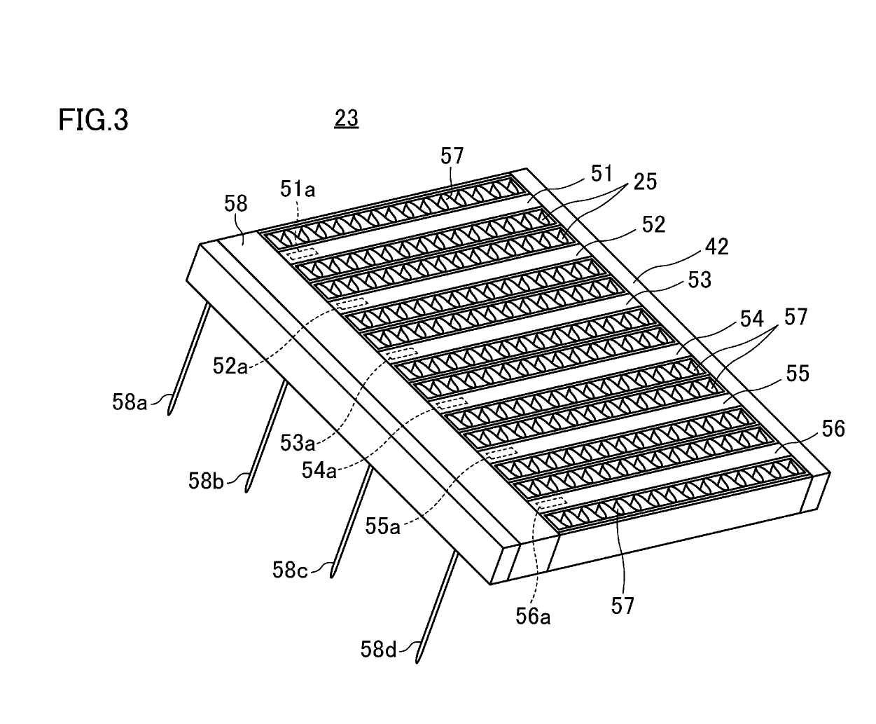

As illustrated in FIG. 3, the electric heater 23 includes first to sixth heater units 51-56, many fins 57, and an electrode holder 58. The first to sixth heater units 51-56 are arranged in this order in a width direction of the electric heater 23, and the fins 57 are provided between each adjacent pair of the first to sixth heater units 51-56, thereby allowing the air-conditioning air to pass through the electric heater 23.

The first to sixth heater units 51-56 have the same configuration and generate substantially the same amount of heat. A PTC element configured to generate heat when supplied with electric power is provided in each of the units 51-56.

The first to sixth heater units 51-56 are divided into three groups. That is, a first anode electrode 58a and a cathode electrode 58d are connected to the first and second heater units 51, 52. A second anode electrode 58b and the cathode electrode 58d are connected to the third and fourth heater units 53, 54. A third anode electrode 58c and the cathode electrode 58d are connected to the fifth and sixth heater units 55, 56.

The PTC element of the first heater unit 51 and the PTC element of the second heater unit 52 are respectively first heater elements 51a and 52a. The PTC element of the third heater unit 53 and the PTC element of the fourth heater unit 54 are respectively second heater elements 53a and 54a. The PTC element of the fifth heater unit 55 and the PTC element of the sixth heater unit 56 are respectively third heater elements 55a and 56a.

The first to third anode electrodes 58a-58c and the cathode electrode 58d are connected to the controller 4, and the first to third anode electrodes 58a-58c are independently supplied with electric power. Supplying electric power to the first anode electrode 58a allows a current to flow through the first heater element 51a of the first and second heater unit 51 and the first heater element 52a of the first and second heater unit 52, so that the first heater elements 51a, 52a generate heat. Supplying electric power to the first and second anode electrodes 58a and 58b allows a current to flow through the first heater elements 51a, 52a of the first and second heater units 51, 52, and the second heater elements 53a, 54a of the third and fourth heater units 53, 54, so that the heater elements 51a, 52a, 53a, 54a generate heat. Supplying electric power to the first to third anode electrodes 58a-58c allows a current to flow through the first heater elements 51a, 52a of the first and second heater units 51, 52, the second heater elements 53a, 54a of the third and fourth heater units 54, 54, and the third heater elements 55a, 56a of the fifth and sixth heater units 55, 56, so that the heater element 51a, 52a, 53a, 54a, 55a, 56a generate heat. In this way, the thermal capacity of the electric heater 23 can be roughly adjusted in three phases.

In the casing 20, a warm air sensor (air temperature sensor) 44 configured to sense the temperature of air having passed through the electric heater 23 is provided downstream of the electric heater 23 in the airflow direction. The warm air sensor 44 is connected to the controller 4 and is configured to output the sensed temperature to the controller 4.

The air mixing damper 25 is configured to open the heating passage R2 and close an upstream end opening which is a part of the bypass passage R3, and vice versa. The air mixing damper 25 is configured to be driven by an air mixing damper actuator 43 which is an element of the air conditioner 1. The air mixing damper actuator 43 is connected to the controller 4 and operates in response to a signal output from the controller 4 having computed a target opening degree which will be described later. The air mixing damper actuator 43 moves the air mixing damper 25 to the target opening degree.

If the air mixing damper 25 is moved as indicated by the solid line in FIG. 1 so that the heating passage R2 is fully closed, air-conditioning air having passed through the cooling passage R1 totally flows through the bypass passage R3 into the air mixing space R4. On the other hand, if the air mixing damper 25 is moved as indicated by the phantom line in FIG. 1 so that the bypass passage R3 is fully closed, the air-conditioning air having passed through the cooling passage R1 totally flows through the heating passage R2 into the air mixing space R4. The movement of the air mixing damper 25 adjusts the opening degrees of the heating passage R2 and the bypass passage R3, thereby regulating the amounts of cold air and warm air flowing into the air mixing space R4.

In the embodiment, the opening degree of the air mixing damper 25 is indicated by the opening degree of the heating passage R2. For example, a situation where the opening degree of the air mixing damper 25 is 100% means a situation where the opening degree of the heating passage R2 is 100% and the opening degree of the cooling passage R1 is 0%, and a situation where the opening degree of the air mixing damper 25 is 0% means a situation where the opening degree of the heating passage R2 is 0% and the opening degree of the cooling passage R1 is 100%. The opening degree of the air mixing damper 25 can be set to any value from 0% to 100%.

Cold air cooled by the evaporator 22 and warm air heated by the electric heater 23 are mixed in the air mixing space R4, thereby generating conditioned air.

The conditioned air generated in the air mixing space R4 is supplied to spaces in the cabin based on the open/close positions of the blowout direction switching dampers 26. Examples of the blowout mode used here include a defroster mode, a vent mode, and a heat mode.

Moreover, the vehicle includes an inside air temperature sensor 60 provided in the cabin to sense an air temperature in the cabin and an outside air temperature sensor 61 provided outside the cabin to sense the air temperature outside the cabin. The inside air temperature sensor 60 and the outside air temperature sensor 61 are elements included in the vehicle air conditioner 1. The inside air temperature sensor 60 and the outside air temperature sensor 61 are connected to the controller 4 and are configured to output the sensed temperature to the controller 4.

The vehicle further includes an insolation sensor 42 configured to determine the amount of insolation. The insolation sensor 42 is an element of the vehicle air conditioner 1 and is connected to the controller 4. The insolation sensor 42 is configured to output the determined amount of insolation to the controller 4.

The controller 4 controls the refrigeration cycle device and also controls the blower 21, the electric heater 23, and the air mixing damper actuator 43. In controlling the refrigeration cycle device, the controller 4 basically controls ON/OFF operation and the rotation speed of the electric compressor 11 based on an air conditioning load (cooling load). Here, the controller 4 obtains the temperature of the evaporator 22 from the output signal of the evaporator sensor 40, and based on the temperature, the controller 4 controls the electric compressor 11.

When a relatively high degree of air conditioning is required, the voltage applied to the blower motor 28 is increased to increase the rotation speed of the blower 21. Whether or not the relatively high degree of air conditioning is required is determined by the controller 4 in a known procedure based on, for example, a temperature set by a passenger, the air temperature in the cabin, the air temperature outside the cabin, etc.

Basically, the controller 4 obtains the computed target opening degree of the air mixing damper 25, and when the target opening degree of the air mixing damper 25 falls within the range of opening degrees for heating (greater than or equal to 50% and less than or equal to 100%), the controller 4 supplies a larger amount of electric power to the electric heater 23 than when the target opening degree of the air mixing damper 25 falls within the range of opening degrees for cooling (greater than or equal to 0% and less than 50%). The target opening degree is varied.

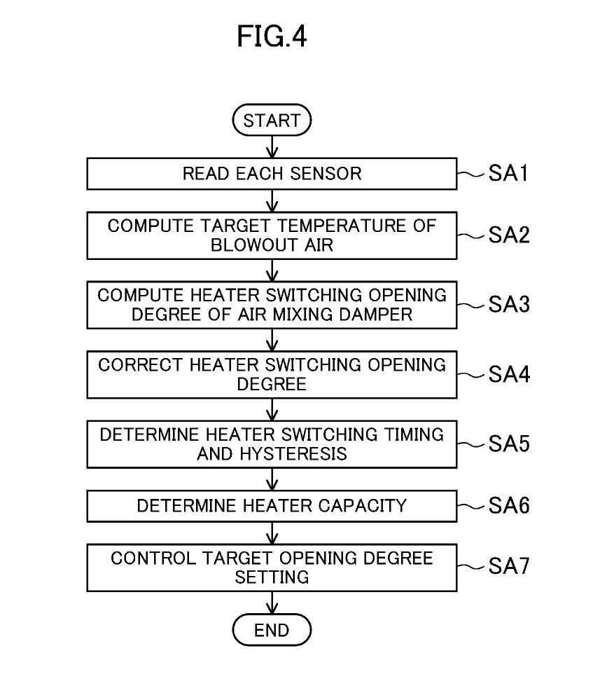

The controller 4 supplies electric power to the electric heater 23 when heating is required. A method for controlling the electric heater 23 by the controller 4 will be described with reference to the flow chart shown in FIG. 4. The control starts immediately after the air conditioner 1 starts operating. The control is repeatedly performed during the operation of the air conditioner 1.

At step SA1 after starting the control, the controller 4 reads output values of the sensors. That is, the controller 4 reads the temperature of air having passed through the evaporator 22, the amount of insolation output from the insolation sensor 42, the temperature of air having passed through the electric heater 23, the air temperature in the cabin, and the temperature outside the cabin. The temperature of air having passed through the evaporator 22 is output from the evaporator sensor 40. The temperature of air having passed through the electric heater 23 is output from the warm air sensor 44. The air temperature in the cabin is output from the inside air temperature sensor 60. The temperature outside the cabin is output from the outside air temperature sensor 61.

At step SA2 following step SA1, a target temperature of blowout air which is the temperature of an air-conditioning wind to be supplied into the cabin is computed. The target temperature of the blowout air is set based on, for example, a temperature set by a passenger, the air temperature in the cabin, the air temperature outside the cabin, the amount of insolation, etc. When the passenger requires a relatively high degree of heating, when the air temperature outside the cabin is low, or when the air temperature in the cabin is low, the target blowout air temperature is set to a high value. On the other hand, when the passenger requires a relatively high degree of cooling, when the air temperature outside the cabin is high, when the air temperature in the cabin is high, or when the amount of insolation is large, the target blowout air temperature is set to a low value.

At step SA3 following step SA2, the heater switching opening degree of the air mixing damper 25 is computed. In this control, the thermal capacity of the electric heater 23 is set based on the opening degree of the air mixing damper 25. The opening degree of the air mixing damper 25 used at the time of setting the thermal capacity of the electric heater 23 is the heater switching opening degree.

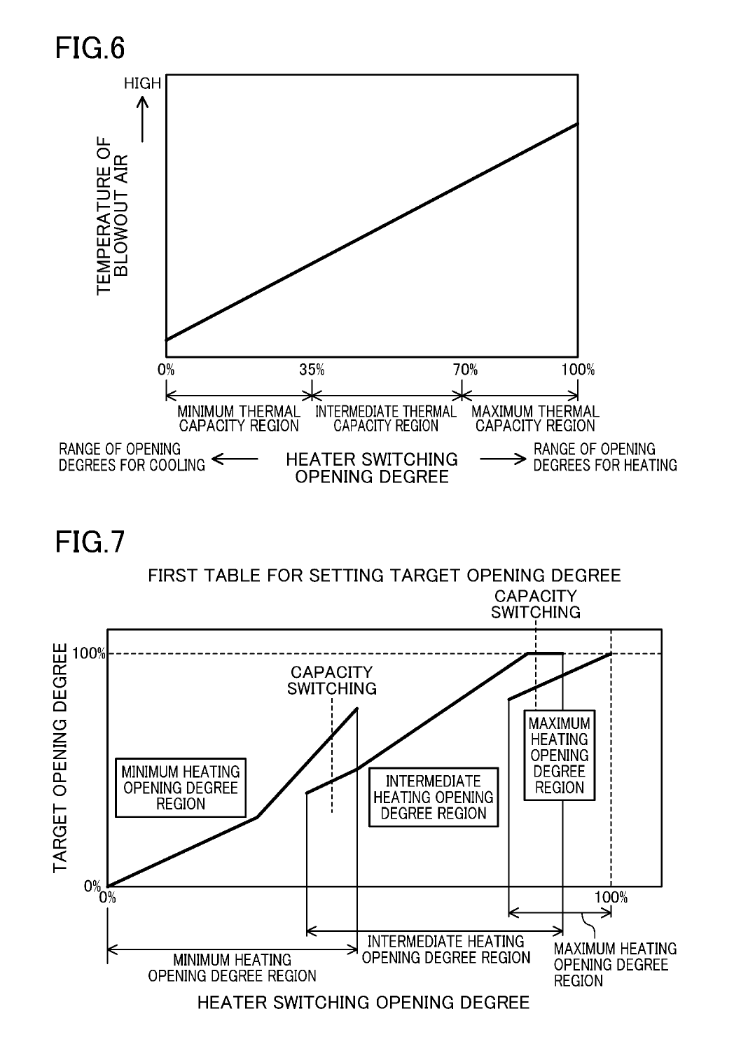

As illustrated in FIG. 6, basically, in the case where the heater switching opening degree of the air mixing damper 25 is within the range from 0% to 35%, a minimum thermal capacity for supplying electric power only to the first and second heater units 51, 52 of the electric heater 23 is selected. In the case where the heater switching opening degree of the air mixing damper 25 is within the range from 36% to 70%, an intermediate thermal capacity for supplying electric power only to the first to fourth heater units 51-54 of the electric heater 23 is selected. In the case where the heater switching opening degree of the air mixing damper 25 is within the range from 71% to 100%, a maximum thermal capacity for supplying electric power to the first to sixth heater units 51-56 of the electric heater 23 is selected. The boundary values (35%, 70%) for switching the thermal capacity may be varied in a later step.

In the case where the thermal capacity of the electric heater 23 is switched from the minimum thermal capacity to the intermediate thermal capacity and then switched from the intermediate thermal capacity back to the minimum thermal capacity, a predetermined hysteresis is provided to prevent hunting. Similarly, a predetermined hysteresis is also provided in each of the case where the thermal capacity of the electric heater 23 is switched from the intermediate thermal capacity to the maximum thermal capacity and then switched from the maximum thermal capacity back to the intermediate thermal capacity, the case where the thermal capacity of the electric heater 23 is switched from the maximum thermal capacity to the intermediate thermal capacity and then switched from the intermediate thermal capacity back to the maximum thermal capacity, and the case where the thermal capacity of the electric heater 23 is switched from the intermediate thermal capacity to the minimum thermal capacity and then switched from the minimum thermal capacity back to the intermediate thermal capacity. The hystereses can be varied as described later.

The heater switching opening degree is the opening degree of the air mixing damper 25 at which the temperature of the blowout air from the casing 20 equals the target blowout air temperature computed at step SA2.

At step SA3, the heater switching opening degree is computed, and then, at step SA4, the heater switching opening degree is corrected based on the amount of insolation and the outside air temperature. As the amount of insolation increases, or as the outside air temperature increases, the heater switching opening degree is reduced, whereas as the amount of insolation decreases, or as the outside air temperature decreases, the heater switching opening degree is increased.

At step SA5 following step SA4, each of timings (boundary values) of switching the thermal capacity of the electric heater 23 and the width of each hysteresis are determined based on the volume of air blown by the blower 21. The volume of air blown by the blower 21 can be obtained with reference to the voltage applied to the blower motor 28.

As the volume of air blown by the blower 21 increases, the timing of switching the thermal capacity of the electric heater 23 is shifted such that the heater switching opening degree of the air mixing damper decreases to cool the air-conditioning air. In contrast, as the volume of blown air decreases, the timing of switching the thermal capacity of the electric heater 23 is shifted such that the heater switching opening degree of the air mixing damper increases to heat the air-conditioning air. Each hysteresis for switching the thermal capacity of the electric heater 23 is varied according to the volume of blown air. Specifically, a higher degree of air conditioning is required when the volume of blown air is large than when the volume of blown air is small. In this case, the width of each hysteresis for switching the thermal capacity of the electric heater 23 is reduced, so that the capacity can be rapidly switched to provide a desirable air conditioning capacity.

Next, the process proceeds to step SA6, at which the thermal capacity of the electric heater 23 is determined based on the graph illustrated in FIG. 6. The thermal capacity determined at step SA6 may be varied in later step SA7. Therefore, the determined thermal capacity is not output to the electric heater 23 but is stored as a provisionally determined thermal capacity.

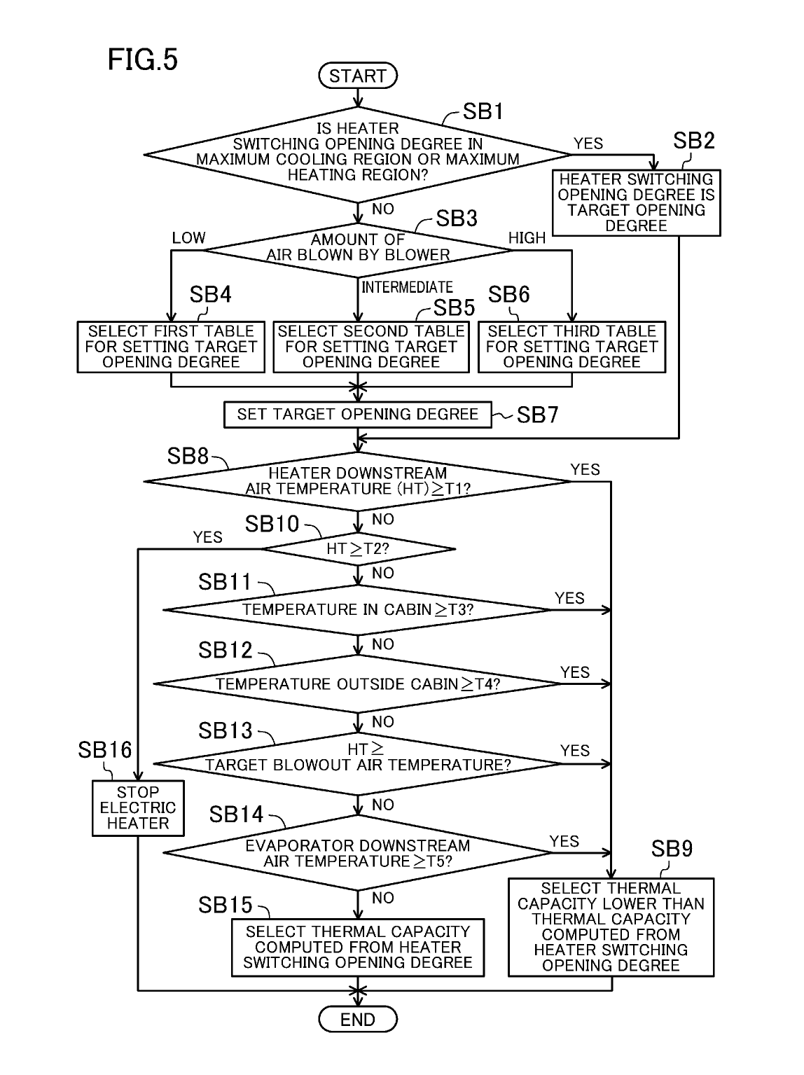

At step SA7, the target opening degree of the air mixing damper 25 is set. This target opening degree setting control will be described based on the flow chart illustrated in FIG. 5.

At step SB1 after the start, it is determined whether the heater switching opening degree of the air mixing damper 25, which has been computed at step SA3, is in a maximum cooling region or in a maximum heating region. The maximum cooling region refers to a region in which the heater switching opening degree is in the range from 0% to 3%. The maximum heating region refers to a region in which the heater switching opening degree is in the range from 97% to 100%.

If YES at step SB1, i.e., if the heater switching opening degree of the air mixing damper 25 is in the maximum cooling region or in the maximum heating region, the process proceeds to step SB2, at which the heater switching opening degree is used as the target opening degree of the air mixing damper 25. The target opening degree is an opening degree to which the air mixing damper 25 is eventually moved. The target opening degree is a value obtained by correcting the heater switching opening degree at step SA4 as described above based on the amount of insolation and the outside air temperature.

If NO at step SB1, i.e., if the heater switching opening degree of the air mixing damper 25 is neither in the maximum cooling region nor in the maximum heating region, the process proceeds to step SB3, at which it is determined whether the volume of blown air from the blower 21 is low, intermediate, or high. If the volume of blown air is low, the process proceeds to step SB4. If the volume of blown air is intermediate, the process proceeds to step SB5. If the volume of blown air is high, the process proceeds to step SB6.

At step SB4, a first table for setting the target opening degree of the air mixing damper 25 is selected. At step SB5, a second table for setting the target opening degree of the air mixing damper 25 is selected. At step SB6, a third table for setting the target opening degree of the air mixing damper 25 is selected.

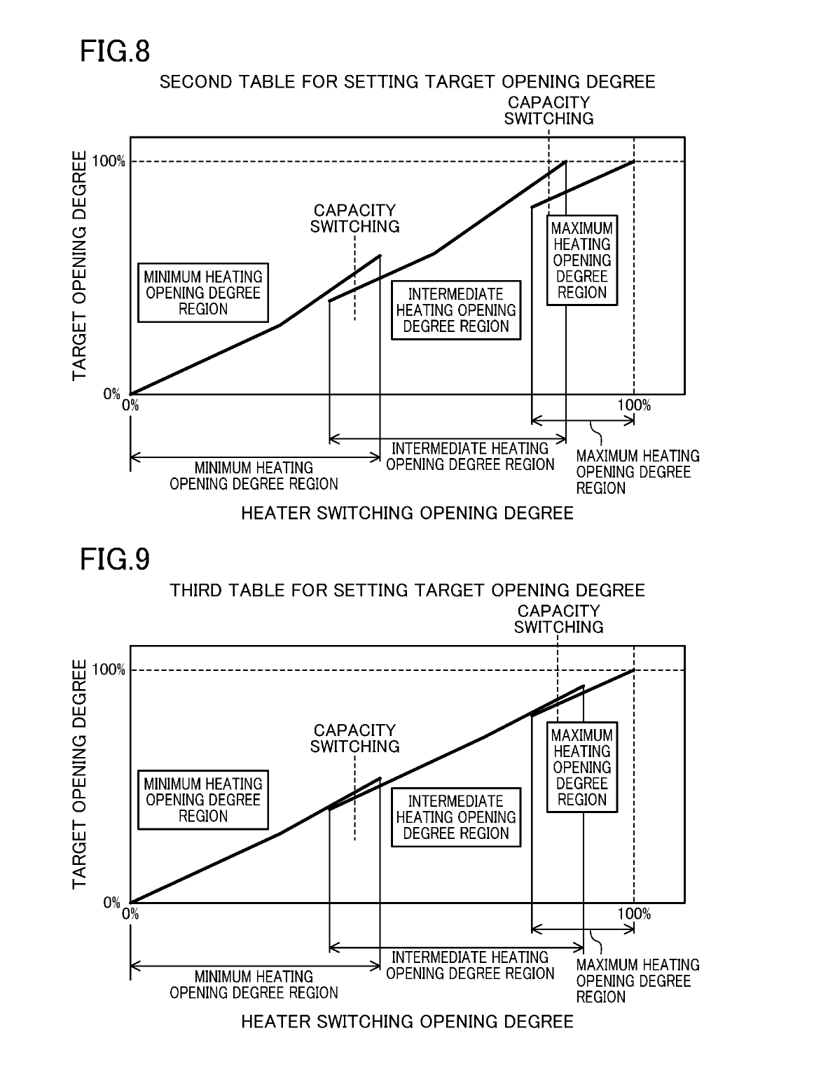

The first, second, and third tables for setting the target opening degree are respectively illustrated in FIGS. 7, 8, and 9. In each of the tables, the target opening degree of the air mixing damper 25 is divided into three regions, i.e., a minimum heating opening degree region, an intermediate heating opening degree region, and a maximum heating opening degree region which each correspond to an associated one of the thermal capacities of the electric heater 23 determined at step SA6. The minimum heating opening degree region overlaps the intermediate heating opening degree region, and the intermediate heating opening degree region overlaps the maximum heating opening degree region. In the first table for setting the target opening degree, the deviation of portions of the lines corresponding to the overlapping parts of the minimum heating opening degree region, the intermediate heating opening degree region, and the maximum heating opening degree region from each other along the vertical axis is greater than in each of the second and third tables for setting the target opening degree. On the other hand, in the third table for setting the target opening degree, the deviation of portions of the lines corresponding to the overlapping parts of the minimum heating opening degree region, the intermediate heating opening degree region, and the maximum heating opening degree region along the vertical axis is smaller than in each of the first and second tables for setting the target opening degree.

In each of the first to third tables for setting the target opening degree, the target opening degree of the air mixing damper 25 along the vertical axis is computed based on the heater switching opening degree (the opening degree computed at step SA3) along the horizontal axis.

The target opening degree of the air mixing damper 25 is set such that when the thermal capacity of the electric heater 23 is switched, the temperature of the blowout air approximates the target temperature.

That is, for example, in the first table for setting the target opening degree, when the thermal capacity of the electric heater 23 is switched from the minimum thermal capacity to the intermediate thermal capacity, the air mixing damper 25 is moved from the target opening degree computed from the heater switching opening degree based on the line corresponding to the minimum heating opening degree region which is a minimum thermal capacity region to the target opening degree computed from the heater switching opening degree based on the line corresponding to the intermediate heating opening degree region which is an intermediate thermal capacity region.

The target opening degree in the intermediate heating opening degree region when the thermal capacity of the electric heater 23 has been switched from the minimum thermal capacity to the intermediate thermal capacity is smaller than the target opening degree in the minimum heating opening degree region.

As described above, the thermal capacity of the electric heater 23 is stepwise switched from the minimum thermal capacity to the intermediate thermal capacity, so that the heating capacity is increased. Thus, the actual opening degree of the air mixing damper 25 is reduced to cool the air-conditioning air by the increase in heating capacity.

That is, upon switching the thermal capacity of the electric heater 23 from the minimum thermal capacity to the intermediate thermal capacity, the target opening degree in the minimum heating opening degree region is set to a smaller value. Therefore, when the thermal capacity of the electric heater 23 is switched, the temperature of the blowout air approximates the target temperature.

When the thermal capacity of the electric heater 23 is switched from the intermediate thermal capacity to the minimum thermal capacity, the air mixing damper 25 is moved from the target opening degree computed from the heater switching opening degree based on the line corresponding to the intermediate heating opening degree region which is the intermediate thermal capacity region to the target opening degree computed from the heater switching opening degree based on the line corresponding to the minimum heating opening degree region which is the minimum thermal capacity region.

The target opening degree in the minimum heating opening degree region when the thermal capacity of the electric heater 23 has been switched from the intermediate thermal capacity to the minimum thermal capacity is greater than the target opening degree in the intermediate heating opening degree region.

As described above, the thermal capacity of the electric heater 23 is stepwise switched from the intermediate thermal capacity to the minimum thermal capacity, so that the heating capacity is reduced. The actual opening degree of the air mixing damper 25 is increased to heat the air-conditioning air by the reduction in heating capacity.

That is, upon switching the thermal capacity of the electric heater 23 from the intermediate thermal capacity to the minimum thermal capacity, the target opening degree in the minimum heating opening degree region is set to a greater value. Therefore, when the thermal capacity of the electric heater 23 is switched, the temperature of the blowout air approximates the target temperature.

The same applies to the case where the thermal capacity of the electric heater 23 is switched from the intermediate thermal capacity to the maximum thermal capacity and the case where the thermal capacity of the electric heater 23 is switched from the maximum thermal capacity to the intermediate thermal capacity.

The target opening degree of the air mixing damper 25 is also set based on the second and third tables for setting the target opening degree in a similar manner. Steps SB4-SB6 illustrate thermal capacity switching control of the present disclosure.

After steps SB4-SB6, the process proceeds to step SB7, at which the target opening degree of the air mixing damper 25 is finally set based on the table selected at any one of steps SB4-SB6.

After the target opening degree of the air mixing damper 25 is set, the process proceeds to step SB8, at which it is determined whether the heater downstream air temperature (HT) (i.e., the temperature of air having passed through the electric heater 23 which is output from the warm air sensor 44) is higher than or equal to a first predetermined temperature (T1). The first predetermined temperature (T1) is set to a temperature which may cause thermal damage to the casing 20, etc., and is preferably, for example, about 80° C.

If YES at step SB8, i.e., if the heater downstream air temperature (HT) is higher than or equal to the first predetermined temperature (T1), the process proceeds to step SB9, at which a thermal capacity lower than the thermal capacity computed from the heater switching opening degree is selected. Then, the process proceeds to the end, and the electric heater 23 is controlled to have the thermal capacity selected at step SB9. This lowers the amount of heat generation of the electric heater 23, so that the thermal damage to the casing 20, etc. can be avoided.

If NO at step SB8, the process proceeds to step SB10, at which it is determined whether the heater downstream air temperature (HT) is higher than or equal to a second predetermined temperature (T2). The second predetermined temperature (T2) is set to a temperature which is higher than the first predetermined temperature (T1), causes thermal damage to the casing 20, etc., and is preferably, for example, about 100° C.

If YES at step SB10, i.e., if the heater downstream air temperature (HT) is higher than or equal to the second predetermined temperature (T2), the process proceeds to step SB16, at which supplying electric power to the electric heater 23 is stopped. In this way, it is possible to prevent the thermal damage to the casing 20, etc.

If NO at step SB10, i.e., if the heater downstream air temperature (HT) is lower than the second predetermined temperature (T2), the process proceeds to step SB11, at which it is determined whether or not the temperature in the cabin sensed by the inside air temperature sensor 60 is higher than or equal to a third predetermined temperature (T3). The third predetermined temperature (T3) is a temperature based on which it is determined whether or not the temperature in the cabin is a temperature at which weak heating is merely required. The third predetermined temperature (T3) is preferably, for example, about 45° C.

If YES at step SB11, i.e., if the temperature in the cabin is higher than or equal to the predetermined temperature (T3), the process proceeds to step SB9, at which a thermal capacity lower than the thermal capacity computed from the heater switching opening degree is selected. Then, the process proceeds to the end, and the electric heater 23 is controlled to have the thermal capacity selected at step SB9. This reduces the electric power consumption of the electric heater 23.

If NO at step SB11, i.e., if the temperature in the cabin is lower than the third predetermined temperature (T3), the process proceeds to step SB12, at which it is determined whether the temperature outside the cabin sensed by the outside air temperature sensor 61 is higher than or equal to a fourth predetermined temperature (T4). The fourth predetermined temperature (T4) is a temperature based on which it is determined whether or not the temperature outside the cabin is a temperature at which weak heating is merely required. The fourth predetermined temperature (T4) is preferably, for example, about 45° C.

If YES at step SB12, i.e., if the temperature outside the cabin is higher than or equal to the predetermined temperature (T4), the process proceeds to step SB9, at which a thermal capacity lower than the thermal capacity computed from the heater switching opening degree is selected. Then, the process proceeds to the end, and the electric heater 23 is controlled to have the thermal capacity selected at step SB9. This reduces the electric power consumption of the electric heater 23.

If NO at step SB12, i.e., if the temperature outside the cabin is lower than the predetermined temperature (T4), the process proceeds to step SB13, at which it is determined whether or not the heater downstream air temperature (HT) is higher than or equal to the target blowout air temperature.

If YES at step SB13, i.e., if the heater downstream air temperature (HT) is higher than or equal to the target blowout air temperature, the process proceeds to step SB9, at which a thermal capacity lower than the thermal capacity computed from the heater switching opening degree is selected. Then, the process proceeds to the end, and the electric heater 23 is controlled to have the thermal capacity selected at step SB9. This reduces the electric power consumption of the electric heater 23.

If NO at step SB13, i.e., if the heater downstream air temperature (HT) is lower than the target blowout air temperature, the process proceeds to step SB14, at which it is determined whether or not the temperature of air having passed through the evaporator 22, which is sensed by the evaporator sensor 40, i.e., a temperature sensed downstream of the evaporator, is higher than or equal to a fifth predetermined temperature (T5). The fifth predetermined temperature T5 is preferably, for example, about 45° C.

If YES at step SB14, i.e., if the temperature sensed downstream of the evaporator is higher than or equal to the predetermined temperature (T5), the process proceeds to step SB9, at which a thermal capacity lower than the thermal capacity computed from the heater switching opening degree is selected. Then, the process proceeds to the end, and the electric heater 23 is controlled to have the thermal capacity selected at step SB9. This reduces the electric power consumption of the electric heater 23.

If NO at step SB14, i.e., if the temperature sensed downstream of the evaporator is lower than the predetermined temperature (T5), the process proceeds to step SB15, at which the thermal capacity computed from the heater switching opening degree is selected. Then, the process proceeds to the end, and the electric heater 23 is controlled to have the thermal capacity selected at step SB9.

Thus, for example, when the thermal capacity of the electric heater 23 is increased from the minimum thermal capacity to the intermediate thermal capacity at step SA6 of the flow chart illustrated in FIG. 4, the thermal capacity of only the electric heater 23 may rapidly increase, so that the blowout air temperature may increase to or exceeds the target temperature. However, in the present embodiment, the target opening degree of the air mixing damper 25 is set at steps SB4-SB7 such that the temperature of the blowout air approximates the target temperature, so that it is possible to prevent wide deviation of the temperature of the blowout air from the target temperature. Thus, when the capacity of the electric heater 23 is switched, the wide deviation of the temperature of the conditioned air from the target temperature is prevented, so that the comfort of passengers can be improved.

If the heater switching opening degree is in the maximum cooling region or in the minimum heating region at step SB1, the process proceeds to step SB2, so that the thermal capacity switching control is not performed at steps SB4-SB6.

In the maximum cooling region, the electric heater 23 is in an OFF state. Therefore, the thermal capacity is not switched. In the maximum heating region, the thermal capacity of the electric heater 23 is maximum. Therefore, the thermal capacity is not switched. Therefore, in the regions in which the thermal capacity of the electric heater 23 is not switched, the thermal capacity switching control is not performed, so that error control can be prevented.

The controller 4 corrects the heater switching opening degree based on the amount of insolation and the outside air temperature at step SA4. Thus, the opening degree of the air mixing damper 25 is set in consideration of the amount of insolation and the temperature outside the cabin. Therefore, the temperature of the conditioned air can be suitably set, so that the comfort of the passengers can be further improved.

At steps SB4-SB6, to increase the thermal capacity of the electric heater 23, the controller 4 sets the target opening degree such that the opening degree of the air mixing damper 25 is reduced to cool the air-conditioning air as compared to the opening degree before the increase, and to reduce the thermal capacity of the electric heater 23, the controller 4 sets the target opening degree such that the opening degree of the air mixing damper 25 is increased to heat the air-conditioning air as compared to the opening degree before the reduction. Thus, in both of the case where the thermal capacity of the electric heater 23 is switched to a higher thermal capacity and the case where the thermal capacity of the electric heater 23 is switched to a lower thermal capacity, it is possible to prevent the wide deviation of the temperature of blowout air from the target temperature, so that the comfort of passengers can be further increased.

The controller 4 may be configured to change the opening degree of the air mixing damper 25 based on the target temperature of the blowout air before switching the thermal capacity of the electric heater 23. That is, if the target temperature of the blowout air before switching the thermal capacity of the electric heater 23 is relatively high, the opening degree of the air mixing damper 25 is increased to heat the air-conditioning air, and if the target temperature of the blowout air before switching the thermal capacity of the electric heater 23 is relatively low, the opening degree of the air mixing damper 25 is reduced to cool the air-conditioning air. Thus, the opening degree of the air mixing damper 25 is set in consideration of the target temperature of the blowout air, so that it is possible to suitably set the temperature of the conditioned air.

The controller 4 is configured to switch the thermal capacity of the electric heater 23 based on the heater switching opening degree of the air mixing damper 25. For example, as illustrated in FIG. 7, the controller 4 is configured such that as time approaches the timing of switching the thermal capacity of the electric heater 23, the difference between the target opening degree of the air mixing damper 25 and the heater switching opening degree increases. That is, before switching the thermal capacity of the electric heater 23, the air mixing damper 25 moves to a target opening degree which is an opening degree different from the heater switching opening degree, so that the difference between the heater switching opening degree and the target opening degree gradually increases. Thus, the temperature of the blowout air can be closer to the target temperature of the blowout air when the thermal capacity of the electric heater 23 is switched than when the electric heater 23 is operated with the air mixing damper 25 open to the heater switching opening degree.

If at step SB8, the controller 4 determines that the temperature of air having passed through the electric heater 23 is higher than or equal to the temperature (T1) which may cause thermal damage to the casing 20, etc., the controller 4 reduces, at SB9, the thermal capacity of the electric heater 23. In this way, the thermal damage can be prevented.

If at step SB10, the temperature of air having passed through the electric heater 23 is higher than or equal to the second predetermined temperature (T2) higher than the first predetermined temperature (T1), the controller 4 stops, at SB9, supplying electric power to the electric heater 23. In this way, the thermal damage can be prevented in advance.

If at step SB11, the air temperature in the cabin sensed by the inside air temperature sensor 60 is higher than the predetermined temperature (T3), the controller 4 reduces, at step SB9, the thermal capacity of the electric heater 23. If the air temperature in the cabin is higher than the predetermined temperature (T3), a low heating capacity of the air conditioner 1 is satisfactory. In this case, the thermal capacity of the electric heater 23 is reduced, so that the electric power consumption can be reduced without reducing the comfort of passengers.

If at step SB12, the temperature outside the cabin sensed by the outside air temperature sensor 61 is higher than the predetermined temperature (T4), the controller 4 reduces, at step SB9, the thermal capacity of the electric heater 23. If the temperature outside the cabin is higher than the predetermined temperature (T4), a low heating capacity of the air conditioner 1 is satisfactory. In this case, the thermal capacity of the electric heater 23 is reduced, so that the electric power consumption can be reduced without reducing the comfort of passengers.

Moreover, the controller 4 may be configured to reduce the thermal capacity of the electric heater 23 when at least one of the air temperature in the cabin sensed by the inside air temperature sensor 60 or the temperature outside the cabin sensed by the outside air temperature sensor 61 is higher than a predetermined temperature. Thus, the electric power consumption can be reduced without reducing the comfort of passengers.

If the temperature of air sensed by the warm air sensor 44 is higher than the target temperature of the blowout air, the controller 4 reduces the thermal capacity of the electric heater 23. If the temperature of air heated by the electric heater 23 is higher than the target temperature of the blowout air, a low heating capacity of the air conditioner 1 is satisfactory. In this case, the thermal capacity of the electric heater 23 is reduced, so that the electric power consumption can be reduced without reducing the comfort of passengers.

If the temperature sensed by the evaporator sensor 40 is higher than the predetermined temperature (T5), the controller 4 reduces the thermal capacity of the electric heater 23. If the temperature of air having passed through the evaporator 22 is higher than the predetermined temperature (T5), a low heating capacity of the air conditioner 1 is satisfactory. In this case, the thermal capacity of the electric heater 23 is reduced, so that the electric power consumption can be reduced.

The controller 4 may be configured to gradually move the air mixing damper 25 over a predetermined delay time after switching the thermal capacity of the electric heater 23. That is, in general, after switching the thermal capacity of the electric heater 23, the thermal capacity of the electric heater 23 gradually changes. The delay time is set such that the air mixing damper 25 is operated with a delay corresponding to the gradual change of the thermal capacity of the electric heater 23, so that a rapid change in temperature of the blowout air can be reduced when the thermal capacity of the electric heater 23 is switched. Thus, the comfort of passengers can be further improved.

The controller 4 may be configured to change each hysteresis for switching the thermal capacity of the electric heater based on the volume of blown air. For example, a higher degree of air conditioning is required when the volume of blown air is high than when the volume of blown air is low. In this case, each hysteresis for switching the thermal capacity of the electric heater 23 is reduced, so that a desirable air conditioning capacity can be obtained by rapidly switching the conditioning capacity.

The controller 4 is configured to switch the thermal capacity of the electric heater 23 based on the heater switching opening degree of the air mixing damper 25. The controller 4 may be configured to shift the timing of switching the thermal capacity of the electric heater 23 such that the heater switching opening degree of the air mixing damper decreases to cool the air-conditioning air as the volume of blown air increases, and shift the timing of switching the thermal capacity of the electric heater 23 such that the heater switching opening degree of the air mixing damper increases to heat the air-conditioning air as the volume of blown air decreases. With this configuration, when the volume of blown air is high in heating, the heating capacity is high. In this case, since the timing of switching the thermal capacity of the electric heater 23 is shifted such that the heater switching opening degree decreases to cool the air-conditioning air, a desirable heating capacity can be ensured. When the volume of blown air is low, the heating capacity is low. Therefore, the timing of switching the thermal capacity of the electric heater 23 is shifted such that the heater switching opening degree increases to heat the air-conditioning air, so that a desirable heating capacity can be ensured. Thus, the timing of switching the thermal capacity of the electric heater 23 can be changed without reducing the air conditioning capacity of the air conditioner 1.

Note that while in the embodiment, the heating capacity of the electric heater 23 can be changed between three phases, i.e., the minimum heating capacity, the intermediate heating capacity, and the maximum heating capacity, the heating capacity is not limited to that can be changed between three phases. The heating capacity may have two phases, or may have four or more phases.

The present disclosure is also applicable to, for example, air conditioners of hybrid vehicles including an engine and a driving motor.

As described above, the vehicle air conditioner according to the present disclosure can be used, for example, as an air conditioner of an electric vehicle.

What is claimed is:

1. A vehicle air conditioner comprising:
a cooling heat exchanger configured to cool air-conditioning air;
an electric heater whose thermal capacity for heating the air-conditioning air is switchable in a plurality of phases;
an air mixing damper configured to regulate amounts of air having passed through the cooling heat exchanger and air having passed through the electric heater;
a driver configured to drive the air mixing damper; and
a controller configured to control the electric heater and the driver such that the thermal capacity of the electric heater is switched, a target opening degree of the air mixing damper is computed, and the driver is operated to move the air mixing damper to the target opening degree so as to obtain blowout air at a target temperature, wherein
when the controller switches the thermal capacity of the electric heater, the controller performs thermal capacity switching control of setting the target opening degree of the air mixing damper such that a temperature of the blowout air approximates the target temperature.

2. The vehicle air conditioner of claim 1, wherein
the controller is configured to perform the thermal capacity switching control in a region except a maximum cooling region and a maximum heating region.

3. The vehicle air conditioner of claim 1, further comprising:
an insolation sensor configured to sense an amount of insolation, wherein
the controller is configured to correct an opening degree of the air mixing damper based on the amount of insolation sensed by the insolation sensor.

4. The vehicle air conditioner of claim 1, further comprising:
an outside air temperature sensor configured to sense a temperature outside a cabin, wherein
the controller is configured to correct an opening degree of the air mixing damper based on the temperature outside the cabin sensed by the outside air temperature sensor.

5. The vehicle air conditioner of claim 1, wherein
the controller is configured to set the target opening degree such that to increase the thermal capacity of the electric heater, the air mixing damper is moved such that an opening degree of the air mixing damper decreases to cool the air-conditioning air as compared to the opening degree before an increase in thermal capacity, whereas to reduce the thermal capacity of the electric heater, the air mixing damper is moved such that the opening degree of the air mixing damper increases to heat the air-conditioning air as compared to the opening degree before a reduction in thermal capacity.

6. The vehicle air conditioner of claim 1, wherein
the controller is configured to change the opening degree of the air mixing damper based on the target temperature of the blowout air before switching the thermal capacity of the electric heater.

7. The vehicle air conditioner of claim 1, wherein
the controller is configured to switch the thermal capacity of the electric heater based on a heater switching opening degree of the air mixing damper, and
the controller is configured to increase a difference between the target opening degree of the air mixing damper and the heater switching opening degree as time approaches a timing of switching the thermal capacity of the electric heater.

8. The vehicle air conditioner of claim 1, further comprising:
an air temperature sensor configured to sense a temperature of air heated by the electric heater, wherein
the controller is configured to reduce the thermal capacity of the electric heater when the temperature of the air sensed by the air temperature sensor is higher than or equal to a first predetermined temperature.

9. The vehicle air conditioner of claim 8, wherein
the controller is configured to stop supplying electric power to the electric heater when the temperature of air sensed by the air temperature sensor is higher than or equal to a second predetermined temperature higher than the first predetermined temperature.

10. The vehicle air conditioner of claim 1, further comprising:
an inside air temperature sensor configured to sense an air temperature in a cabin, wherein
the controller is configured to reduce the thermal capacity of the electric heater when in introducing inside air from the cabin into the vehicle air conditioner, the air temperature in the cabin sensed by the inside air temperature sensor is higher than the predetermined temperature.

11. The vehicle air conditioner of claim 1, further comprising:
an outside air temperature sensor configured to sense an air temperature outside a cabin, wherein
the controller is configured to reduce the thermal capacity of the electric heater when in introducing air outside the cabin into the vehicle air conditioner, the air temperature outside the cabin sensed by the outside air temperature sensor is higher than a predetermined temperature.

12. The vehicle air conditioner of claim 1, further comprising:
an inside air temperature sensor configured to sense an air temperature in a cabin; and
an outside air temperature sensor configured to sense a temperature outside the cabin, wherein
the controller is configured to reduce the thermal capacity of the electric heater when at least one of the air temperature in the cabin sensed by the inside air temperature sensor or the temperature outside the cabin sensed by the outside air temperature sensor is higher than a predetermined temperature.

13. The vehicle air conditioner of claim 1, further comprising:
an air temperature sensor configured to sense a temperature of air heated by the electric heater, wherein
the controller is configured to reduce the thermal capacity of the electric heater when the temperature of the air sensed by the air temperature sensor is higher than a target temperature of blowout air.

14. The vehicle air conditioner of claim 1, further comprising:
a cooling-side temperature sensor configured to sense a temperature of air having passed through the cooling heat exchanger, wherein
the controller is configured to reduce the thermal capacity of the electric heater when the temperature sensed by the cooling-side temperature sensor is higher than the predetermined temperature.

15. The vehicle air conditioner of claim 1, wherein
the controller is configured to move the air mixing damper after a predetermined delay time has elapsed since the thermal capacity of the electric heater was switched.

16. The vehicle air conditioner of claim 1, wherein
the controller is configured to change a hysteresis for switching the thermal capacity of the electric heater based on a volume of blown air.

17. The vehicle air conditioner of claim 1, wherein
the controller is configured to switch the thermal capacity of the electric heater based on a heater switching opening degree of the air mixing damper, and
the controller shifts a timing of switching the thermal capacity of the electric heater such that the heater switching opening degree decreases to cool the air-conditioning air as a volume of blown air increases, whereas the controller shifts the timing of switching the thermal capacity of the electric heater such that the heater switching opening degree increases to heat air-conditioning air as the volume of the blown air decreases.
